(19) United States
(12) Patent Application Publication
(10) Pub. No.: US 2010/0200147 A1
(43) Pub. Date: Aug. 12, 2010

(54) Adhesive bonding method

(75) Inventors: Wingkeung Mak, Hong Kong (CN); Tinhoi Siu, Hong Kong (CN); Xiaoxi Liu, DongGuan (CN); Gamboa Guillen, DongGuan (CN); Dianjun Gong, DongGuan (CN); Wei Si, DongGuan (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 12/458,842

(22) Filed: Jul. 23, 2009

(30) Foreign Application Priority Data
Feb. 6, 2009 (CN) 200910004057.8

(51) Int. Cl. B32B 38/00; B32B 37/06

(52) U.S. Cl. 156/64; 156/275.5

(57) ABSTRACT

The present invention provides an adhesive bonding method including: providing a first component and a second component to be bonded and an adhesive; positioning the adhesive between the first component and the second component with the adhesive contacting with the first component and the second component; providing at least one light concentrator; and providing a light source and making at least partial light beams of the light source pass through the light concentrator and the first component in order, and then irradiate on the adhesive to cure the adhesive so as to bond the first component and the second component. The adhesive bonding method of the instant invention can maintain the alignment precision between the components being bonded so as to optimize products' performances. The invention also provides a plate installing device with a light concentrator, which can be installed by the adhesive bonding method above mentioned.

### FIELD OF THE INVENTION

The present invention relates to a bonding method and, more particularly, to an adhesive bonding method with a light concentrator.

### BACKGROUND OF THE INVENTION

Polymer adhesive bonding processes are widely used by industry owing to its economy and simplicity in processing. In recent years, development of adhesive technology had greatly improved product performance and stability, it has begun to be applied in the highly demanded photonics packaging. A key application of the polymer adhesive in photonics packaging is to hold components in their best functioning optical positions, which is commonly known as alignment, from the time a product was manufactured till the product end-of-service. Allowable displacement is typically less than few micrometers. The selection of adhesive suitable for the application usually falls into two categories, namely thermoplastic and thermosetting. Thermoplastic adhesive is simply applied to joint parts at elevated temperature when the polymer is soft and adhesive is reduced. It hardens when cool down and holds parts firmly. It is suitable for applications that subsequent processes temperature do not exist adhesive fusion point and the requirement on creep resistant is not high for the product. The second class is the thermosetting adhesives, also known as curable adhesives. Curable adhesive are irreversibly solidified by the formation of inter-molecule cross-linking in polymer during curing process. After curing, adhesive is converted into an infusible and permanently solid.

Curable adhesives are synthetic polymers with high molecular weight, which react by polymerization to form hard substance, usually with high strength and rigidity. Common curable adhesive types including, epoxy, silicone, polyester, acrylic, polyurethane, neoprene, vinyl adhesive, phenolic adhesive, etc are commonly found in photonic packaging. Traditionally, curable adhesives are favorable over thermoplastic adhesive in order to minimize the alignment change for assembly parts in photonics packaging owning to its high modulus of elasticity, not supporting combustion and chemically insert natures. Classifying with curing process, the three popular kinds of adhesives are heat-curable, light-curable and heat-light curable.

The curing process for any thermosetting adhesive requires to transform the un-processed adhesive applied between parts to be joint, into cured form the further permanent change is prohibited. The curing is essentially a process to increase the amount of cross-linking in the polymer. In typical curing process, viscosity of adhesives will increase gradually from a relatively low value, through the gel point, toward the completion of curing. In thermosetting polymer, the gel point is reached when sufficient cross-linking between molecules within polymer to inhabit the flow characteristics of the polymer body. In the other word, gel point can be referred as the point that polymer's or adhesive's viscosity approaching infinite value.

FIG. 1a is a schematic view illustrating two components being bonded using a conventional bonding method with heat-curable adhesive. As shown in FIG. 1a, after a first component 101a and a second component 102a are aligned with each other, the second component 102a is heated. Heat (represented by arrows in the figure) is conducted to the heat-curable adhesive 103a between the first component 101a and the second component 102a to cure it such that the first component 101a and the second component 102a are bonded together. In most applications, coefficient of thermal expansion (CTE) of the first component 101a and the second component 102a are not identical. Namely, the profiles of the first component 101a and the second component 102a change from the solid line to the dash line as shown in FIG. 1a if the CTEs of both components are positive. Alignment between the first component 101a and the second component 102a will be changed to a new equilibrium position at curing temperature, which might be different from the initial position and the new position is sensitive to number of influences, such as uniformity of adhesive and expansions, before the adhesive is able to hold two parts permanently. Typical heat curing process lead to alignment change and internal stress between components being fixed by adhesive, and in turn, decreases the performance of the product.

FIG. 1b is a schematic view illustrating two components being bonded using another conventional bonding method with light-curable adhesive. Referring to FIG. 1b, after a first component 101b and a second component 102b are aligned with each other, irradiate the first component 101b with light. The light passes through the first component 101b and then irradiates on a light-curable adhesive 103b between the first component 101b and the second component 102b to make it to be cured so as to bond the first component 101b and the second component 102b. An intense light is often used in manufacturing to achieve desirable light curing adhesive bonding process. In general light curing bonding system, more optical power will be absorbed by the portions of a component near the surface of the component irradiated by light, for instance when component 101b is plastic or semiconductor material. Hence, the portion of the first component 101b closer to the surface irradiated by light has a higher temperature. As shown in dash line, the non-uniform temperature will result in a deformation of the first component 101b, which leads to alignment change between the first component 101b and the second component 102b and, in turn, reduces the products' performance.

There is another cause of alignment change from external influences, such as gravity and external force imposes to the system before sufficient strength of the adhesive is developed. This is more often happened in prolonged or multiple steps adhesive bonding process. As shown in FIG. 1c, the bonding strength of the adhesive 103c formed during the alignment procedure might be insufficient to prevent first component 101c creeps relative to the second component 102c, as shown in FIG. 1c before cured. This in turns, reduce the products' performance.

The development of the strength of curable adhesive is illustrated in FIG. 2, x-axis denotes curing time of an adhesive, and y-axis on the left indicates viscosity (η) of the adhesive. Typically viscosity of the adhesive, the curve T1, increases with the curing time and gradually approaching infinite value when gel point is reached. Curing beyond the gel point, adhesive is behaved like solid that mechanical strength (S), the T2 curve, can be used to describe the bonding strength at any particular time. This behavior is important in estimating the duration of curing, and whether sufficient strength is developed.

Thus, there is a need for a short process time adhesive bonding method at the same time alignment shift is minimized.

### SUMMARY OF THE INVENTION

One objective of the present invention is to provide an adhesive bonding method which is capable of locating or fixing the components to be bonded quickly so as to maintain the best functioning positions of the components.

To achieve the above-mentioned objective, the present invention provides an adhesive bonding method comprising: providing a first component and a second component to be bonded together, and an adhesive; positioning the adhesive between the first component and the second component with the adhesive contacting with the first component and the second component; providing at least one light concentrator; and providing a light source and making at least partial light beams of the light source pass through the light concentrator and the first component in order, and then irradiate on the adhesive to cure the adhesive so as to bond the first component and the second component.

Concretely, the first component can be made of glass or plastic or semiconductor or ceramic, and the second component can be a PCB (printed circuit board), a substrate, a chip or a lead frame.

As an embodiment of the present invention, the light concentrator is a lens or a focuser or a light-guide. Alternatively, the light concentrator may be a spherical lens, a cylindrical lens, a polygonal-cylindrical lens, an aspheric-cylindrical lens or a lens having a diffractive optical surface or a light-guiding device with light input aperture larger than exit end.

As another embodiment of the present invention, the step of providing at least one light concentrator is accomplished by integrally forming the light concentrator on the first component. Alternatively, the light concentrator is embedded into the first component as a separated optical element.

As still another embodiment of the present invention, the step of providing at least one light concentrator is accomplished by placing the light concentrator above the first component.

As yet another embodiment of the present invention, the adhesive bonding method further comprises a step of optically aligning the first component with the second component.

In comparison with conventional bonding methods, the adhesive bonding method of the present invention adopts at least one light concentrator to increase illumination at local region where the adhesive can be cured faster. In this new approach, sufficient strength for bonding components together can be obtained in a short time because of higher intensity at the light concentrated region reduce the curing time for adhesive to reach bonding strength (S) on the T2 curve on FIG. 2. Heat generated by material absorption on component will also be reduced and hence smaller thermal deformation on component can be reduced under same light intensity use for curing. Thus using light concentrator in curing process can reduce misalignment, in turns, optimizes products' performance. The adhesive bonding method of the present invention divides the cured adhesive into a fast curing region where the adhesive achieves sufficient adhesive strength in order to secure the alignment precision, and a slow curing region where the adhesive is further cured to reinforce overall mechanical connection stability.

Preferably, the adhesive bonding method of the present invention further comprises monitoring alignment between the first component and the second component, which secures the alignment precision between the components being bonded and, in turn, optimizes performance of products.

The present invention provides a plate installing device which can be installed on a plate by an adhesive. The plate installing device comprises a first surface adapted to touch with the adhesive attached on a plate and a second surface opposite to the first surface. A light concentrator is deposited on the second surface at a position corresponding to the adhesive.

Concretely, the plate installing device is a FOT (Fiber Optic Transceiver), and the plate can be a printed circuit board, a substrate, a chip or a lead frame.

Alternatively, the light concentrator is formed integrally on the second surface or embedded into the second surface as a separated element.

### BRIEF DESCRIPTION OF THE DRAWINGS

The accompanying drawings facilitate an understanding of the various embodiments of this invention. In such drawings:

FIG. 1a is a schematic view illustrating two components being bonded using a conventional method with a heat-curable adhesive;

FIG. 1b is a schematic view illustrating two components being bonded using another conventional method with a light-curable adhesive;

FIG. 1c is a schematic view illustrating two components being bonded using a conventional bonding method;

FIG. 2 is a graph illustrating the relationship between viscosity, bonding strength of curable adhesive and the curing time thereof;

FIG. 3a is a flow chart illustrating an adhesive bonding method according to a first embodiment of the present invention;

FIG. 3b is a schematic view illustrating two components being bonded using the adhesive bonding method as shown in FIG. 3a;

FIG. 4a is a schematic view illustrating bonding components with an adhesive bonding method according to a second embodiment of the present invention;

FIG. 4b is another schematic view of the second embodiment as shown in FIG. 4a;

FIG. 4c is a flow chart illustrating the adhesive bonding method according to the second embodiment of the present invention;

FIG. 5a is a schematic view of bonding components with an adhesive bonding method according to a third embodiment of the present invention;

FIG. 5b is another schematic view of the third embodiment as shown in FIG. 5a;

FIG. 6 is a schematic view illustrating bonding components with the adhesive bonding method according to a fourth embodiment of the invention;

FIG. 7 is a perspective view illustrating bonding components with the adhesive bonding method according to a fifth embodiment of the invention;

FIG. 8a is a schematic view illustrating bonding components with the adhesive bonding method according to a sixth embodiment of the invention;

FIG. 8b is another schematic view illustrating bonding components with the adhesive bonding method according to a sixth embodiment of the invention;

FIG. 9a-9b are schematic views illustrating bonding components with the adhesive bonding method according to a seventh embodiment of the invention;

FIG. 10 is a graph illustrating the bonding shifts between components bonded respectively with the conventional adhesive bonding method and the adhesive bonding method of the present invention after the adhesive being cured.

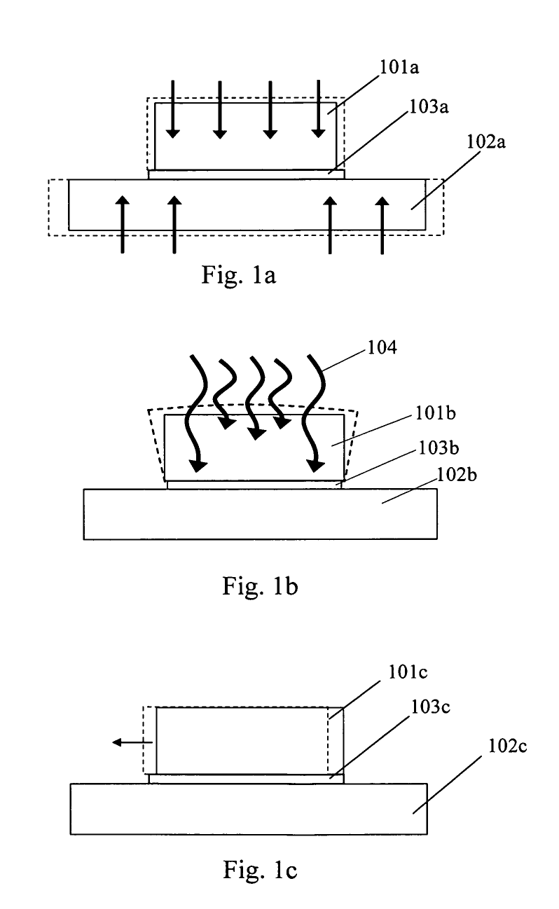

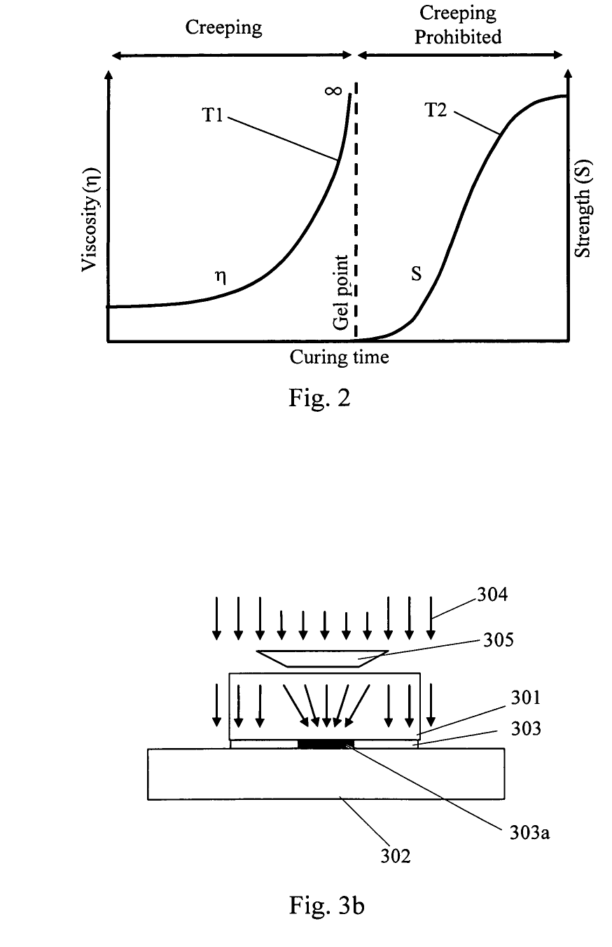

### DETAILED DESCRIPTION OF ILLUSTRATED EMBODIMENTS

Various preferred embodiments of the instant invention will now be described with reference to the figures, wherein like reference numerals designate similar components throughout the various views. Base on the embodiments of the invention, one person having the ordinary skills makes various modifications and equivalent arrangements included within the spirit and scope of the invention.

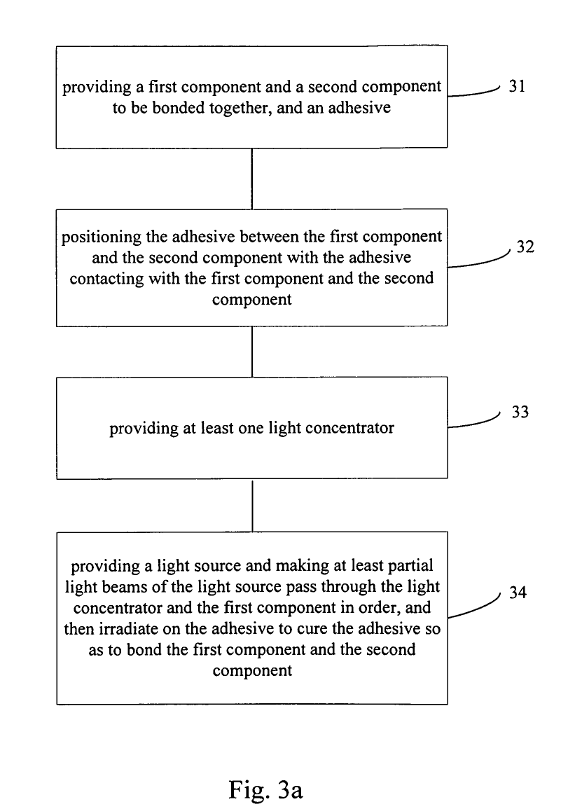

Now, according to a first embodiment of the present invention, an adhesive bonding method is described with reference to FIG. 3a and FIG. 3b. As shown in FIG. 3a, the adhesive bonding method of the first embodiment includes the following steps.

Step 31: Providing a first component 301 and a second component 302 to be bonded together and an adhesive 303. The first component 301 may be a light transmission body made of glass or plastic or semiconductor or ceramic, and the second component 302 may be a printed circuit board, a substrate, a chip or a lead frame, and the adhesive 303 may be a light-curable, heat-curable or light-heat curable adhesive.

Step 32: Positioning the adhesive 303 between the first component 301 and the second component 302 with the adhesive 303 contacting with the first component 301 and the second component 302.

Step 33: providing at least one light concentrator 305 which is located above the first component 301. And the light concentrator 305 may be a lens or a focuser.

Step 34: providing a light source (not shown) and making at least partial light beams 304 pass through the light concentrator 305 and the first component 301 in order, and then irradiate on the adhesive 303 to cure the adhesive 303 so as to bond the first component 301 and the second component 302 together.

Concretely, the curing process of the adhesive 303 in Step 34 can be divided into two steps: fast curing partial adhesive 303, regarded as the first step, and curing entire adhesive 303, regarded as second step. As shown in FIG. 3b, after transmitting through the light concentrator 305, a plurality of light beams 304 focus on local region of the adhesive 303, namely a fast curing region 303a. With the illumination intensity in the fast curing region 303a increasing, the adhesive 303 in the fast curing region 303a is cured quickly, and achieves sufficient bonding strength in a short time, which prevents post-curing alignment change between the first component 301 and the second component 302 resulting from the creeping of the first component 301 such that it ensures alignment precision between components 301, 302. Due to the weak illumination intensity, the adhesive 303 deposited beyond the fast curing region 303a is further illuminated or heated to make all of the adhesive 303 to be fully cured to reinforce the bonding of the first component 301 and the second component 302 so as to guarantee the stability of mechanical integrity.

In addition, since the adhesive 303 in the fast curing region 303a is cured enough in a short time to maintain the positions of the first component 301 and the second component 302 relative to each other, the curing time of the adhesive is shortened such that the deformation induced by the increased temperature resulting from light illuminating is reduced and, in turn, the alignment shift between the components 301, 302 caused by the deformation can be reduced. In another words, the adhesive bonding method of the present invention can restrain the alignment shift between the components being bonded during the products' manufacturing process, such as to guarantee the components being in their best functioning positions, increase the alignment precision and, in turn, optimize products' performances.

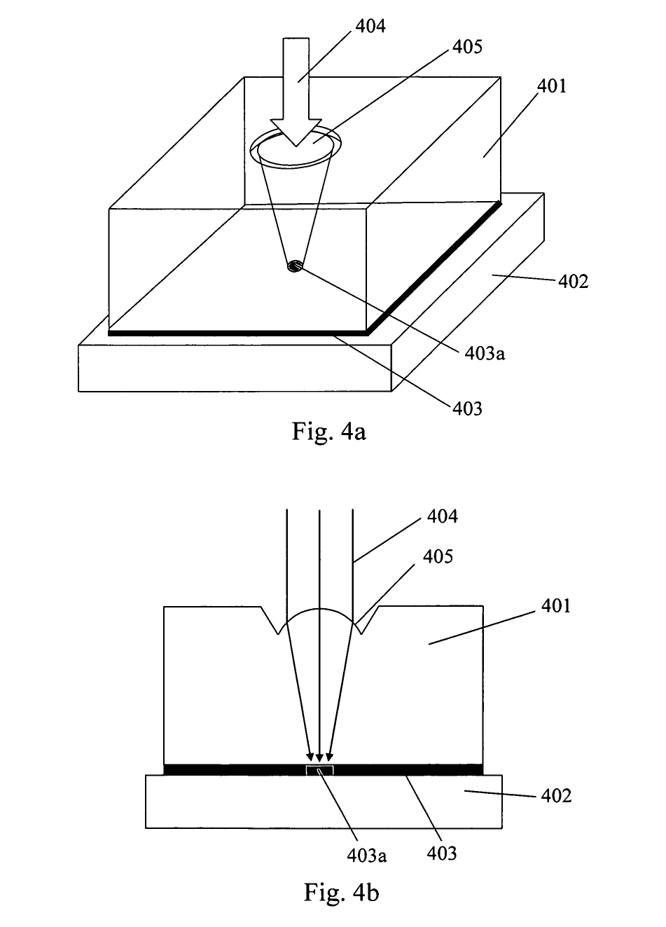

FIG. 4a and 4b are perspective views illustrating bonding components with the adhesive bonding method according to a second embodiment of the present invention, and FIG. 4c is a flow chart illustrating the adhesive bonding method according to the second embodiment of the instant invention. Referring to FIG. 4a-4c, the adhesive bonding method of the second embodiment includes the following steps.

Step 41: Providing a first component 401 and a second component 402 to be bonded together and an adhesive 403. The first component 401 may be a light transmission body made of glass or plastic or semiconductor or ceramic, and the second component 402 may be a printed circuit board, a substrate, a chip, or a leadframe, and the adhesive 403 can be a light-curable, heat-curable or light-heat curable adhesive.

Step 42: Positioning the adhesive 403 between the first component 401 and the second component 402 with the adhesive 403 contacting with the first component 401 and the second component 402.

Step 43: Optically aligning the first component 401 with the second component 402, namely, making the first component 401 and the second component 402 to be located at the relative positions where they can exert their best performances.

Step 44: Providing at least a light concentrator 405; concretely, the light concentrator 405 is integrally formed on the first component 401 or is embedded into the first component 401. The light concentrator 405 may be a lens or a focuser. In the embodiment, the light concentrator 405 is a spherical lens integrally formed on the first component 401.

The number of light concentrator 405 is not limited to one, but can be set for several in accordance with actual needs.

Step 45: Providing a light source (not shown) and making at least partial light beams 404 pass through the light concentrator 405 and the first component 401 in order, and then irradiate on the adhesive 403 to cure it so as to bond the first component 401 and the second component 402 together.

Similarly, the curing process of the adhesive 403 in Step 45 can be divided into two steps: fast curing partial adhesive 403, regarded as the first step, and curing entire adhesive 403, regarded as the second step. As shown in FIG. 4b, after transmitting through the light concentrator 405, a plurality of light beams 404 focus on local region of the adhesive 403, namely a fast curing region 403a. With the illumination intensity in the fast curing region 403a increasing, the adhesive 403 in the fast curing region 403a is cured quickly, and achieves sufficient bonding strength in a short time, which prevents post-curing alignment change between the first component 401 and the second component 402 resulting from the creeping of the first component 401. Finally, it ensures alignment precision between components 401, 402. Due to the weak illumination intensity, the adhesive 403 beyond the fast curing region 403a needs to be further illuminated or heated to make the entire adhesive 403 to be fully cured to reinforce the bonding of the first component 401 and the second component 402 so as to guarantee stability of mechanical integrity.

Moreover, since the adhesive in the fast curing region 403a is cured enough in a short time to maintain the positions of the first component 401 and the second component 402 relative to each other, the curing time of the adhesive is shorten such that the deformation induced by the increased temperature resulting from light illuminating is reduced and, in turn, the alignment shift between the components 401, 402 caused by the deformation can be reduced. That is, the adhesive bonding method of the present invention can restrain the alignment shift between the components being bonded during the product manufacturing process, thus guaranteeing the components being in their best functioning positions, and increasing the aligning precision and, in turn, optimizing products' performances.

The illumination intensity of the fast curing region 403a can be 5 to 10 times as the original. And the illumination intensity can be obtained by adjusting light incident angle and altering the shape and refractive index of lens. Not necessary to be described in detail, the arts are well known by the person having the ordinary skills.

Preferably, the adhesive bonding method of this embodiment may further includes a step of monitoring the alignment between the first component 401 and the second component 402 so as to secure the alignment precision between the components to be bonded together, and ensure high performance of products.

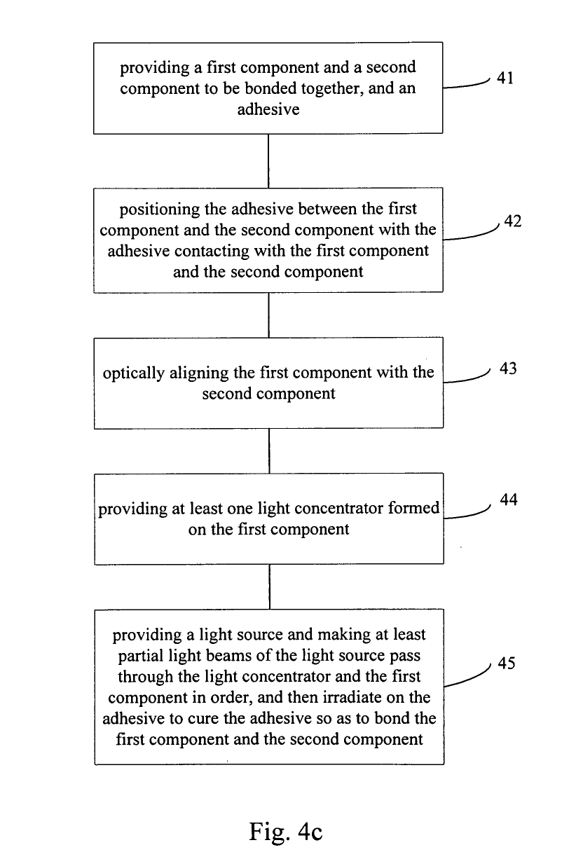

According to a third embodiment of the present invention, an adhesive bonding method is described with reference to FIG. 5a and FIG. 5b. As shown in FIGS. 5a and 5b, the embodiment is similar to the second embodiment, except that the light concentrator 505 of this embodiment is a polygonal-cylindrical lens; accordingly, the shape of the fast curing region 503a is rectangular.

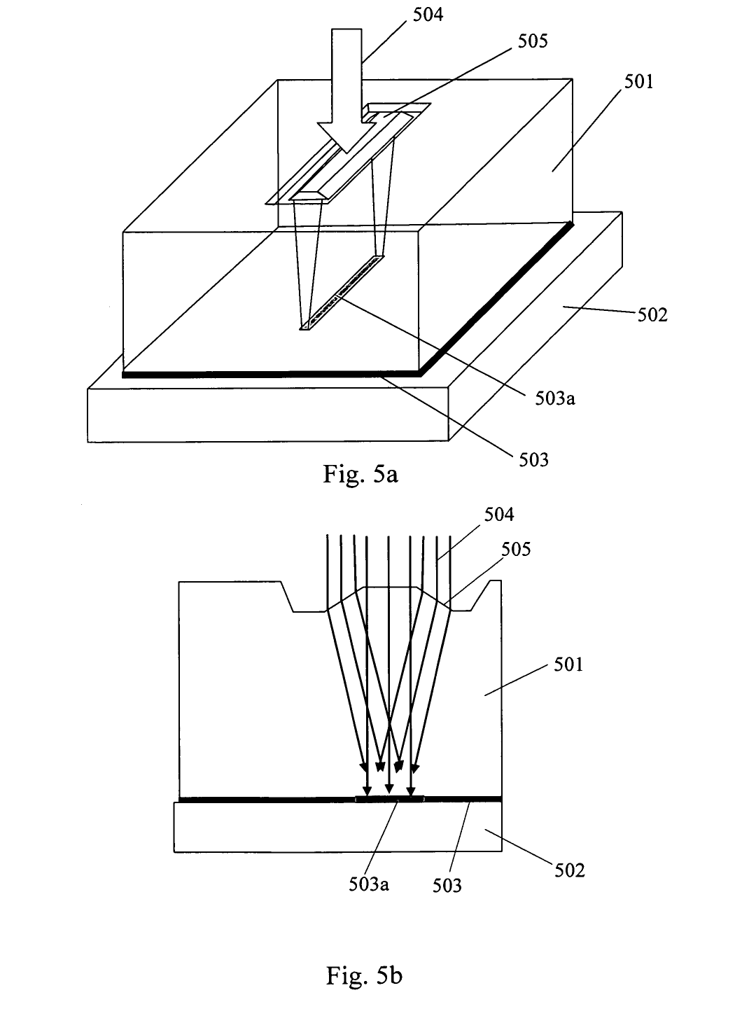

FIG. 6 illustrates bonding components with the adhesive bonding method according to a fourth embodiment of the present invention. Referring to FIG. 6, the difference between the fourth embodiment and the second embodiment is that the light concentrator 605 is a cylindrical lens so that a corresponding fast curing region 603a is rectangular.

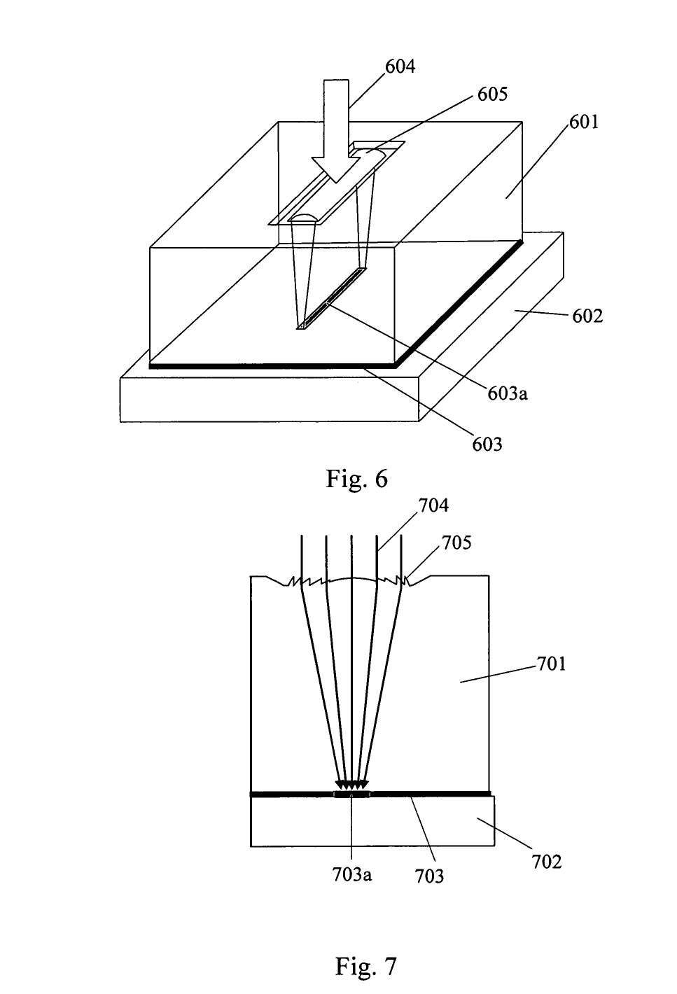

FIG. 7 illustrates bonding components with the adhesive bonding method according to a fifth embodiment of the invention. As shown in FIG. 7, the distinction between the fifth embodiment and the second embodiment is: the light concentrator 705 of the fifth embodiment is a lens having a diffractive optical surface, through which a plurality of light beams 704 pass and then concentrate on local region of the adhesive, namely a fast curing region 703a, such that the adhesive in the fast curing region 703a is cured quickly to obtain enough bonding strength to maintain the positions of the first component 701 and the second component 702.

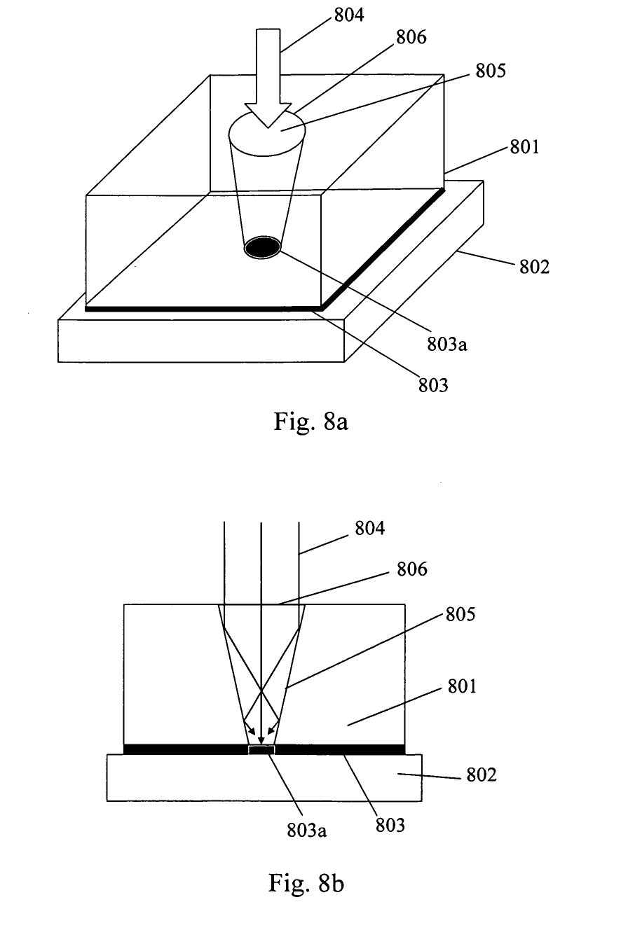

FIGS. 8a-8b illustrate bonding components with the adhesive bonding method according to a sixth embodiment of the invention. As shown in FIGS. 8a and 8b, the embodiment is similar to the second embodiment, except that the light concentrator 805 of this embodiment is an embedded light guiding device on the first component; accordingly, the output area of the light guiding device is smaller compare to that of the input area 806, such that light intensity at the fast curing region 803a is higher. Light illuminated on input area 806 transmit into light guiding device will be reflected by the interface between the first component 801 and the light guiding device by total-internal-reflection or reflective coating so that light reaching the fast curing region 803a will have higher light intensity. Accordingly, the shape of the light guide shown is a cone or a pyramid.

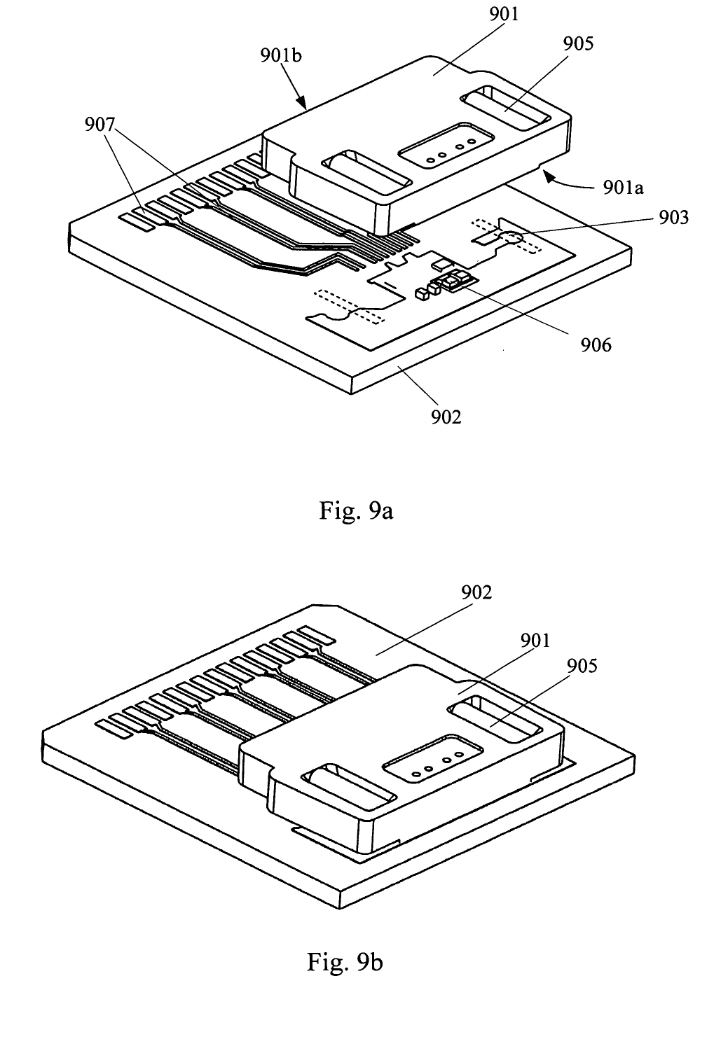

FIGS. 9a-9b are schematic views using a seventh embodiment of the adhesive bonding method of the instant invention, illustrating the adhesive bonding method of the present invention is applied to the field of photonics packaging. In the sixth embodiment, the first component 801 is an optical communication device, such as a commercial FOT( Fiber Optic Transceiver) connector, and the second component 802 is a PCB(printed circuit board), on which circuit patterns 807, and an optical emission/detection device 806 used for aligning the first component 801 with the second component 802 are formed. It is knowable that the first component 801 is not limited to a FOT connector, but can be an active optical cable connector and so on; and the second component 802 is not limited to a PCB, but a substrate, a chip or a leadframe. Turning to FIGS. 8a and 8b, a pair of light concentrators 805 is integrally formed on the first component 801. After the optical emission/detection device 806 aligns optically the first component 801 with the second component 802, a plurality of light beams through the light concentrators 805 irradiate in a region 803 shown in dash lines in FIG. 8a. With the adhesive in the region 803 being cured fast, the first component 801 and the second component 802 are bonded together so as to make the first component 801 mount on the second component 802 steadily. Simultaneously, the adhesive curing time is reduced, which avoids alignment shift resulting from deformation of the first component 801 and, in turn, optimizes performance of the optical communication device.

It should be noted that the adhesive bonding method of the present invention may utilize any suitable lens or lens group, which is capable of condensing light, with different shapes, such as aspheric cylindrical, not limiting to the above-mentioned shapes, such as cylindrical, and the number of the lens can be changed in accordance with actual needs.

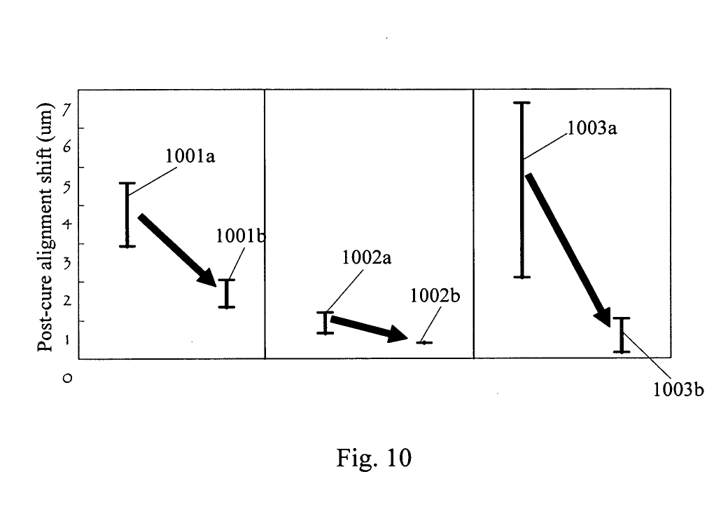

FIG. 10 is a graph illustrating the post-cure bonding shifts between components respectively bonded with the conventional adhesive bonding method and the adhesive bonding method of the present invention. Referring to FIG. 10, Line segment 1001a depicts post-cure alignment shift between the components which are bonded together using a traditional bonding method with a heat-curable adhesive. And Line segments 1002a and 1003a respectively depict the conditions of post-cure alignment shifts between the components which are bonded together using the traditional method under the irradiation of low intensity UV light and high intensity UV light. From the figures, it can be seen that the alignment shift between components being bonded is reduced obviously using the adhesive bonding method of the present invention with a light concentrator, as shown by Line segments 1001b, 1002b and 1003b, especially, under the irradiation of low intensity UV light, 1002b.

Tables 1 and 2 show effects of bonding components using the conventional adhesive bonding method, the second embodiment and the fourth embodiment of the present invention with being irradiated for different illumination time, respectively. The aforesaid three methods are applied to bond the same mould group. Table 1 shows the post-curing bonding shift condition of the mould group after being illuminated by 0.15 w ultraviolet light for 3 seconds, and Table 2 illustrates the bonding shift condition of the mould group after being illuminated by 0.15 w ultraviolet light for 7 seconds. It can be seen from Tables 1 and 2 that mould group 1 without a light concentrator, namely the mould group bonded using a traditional method, has larger post-curing alignment bonding shift because the adhesive has not been cured enough to develop sufficient bonding strength; while mould groups 2 and 3 employing respectively spherical lens and cylindrical lens as a light concentrator have smaller post-curing alignment shifts. Owning to the adhesive in the light-concentrating region having been cured, its bonding strength is sufficient to maintain the relative position between the mould components, and therefore the adhesive bonding method of the present invention can increase post-curing alignment precision and, in turn, optimize products' performances.

TABLE 1
(0.15 W 3 S UV curing)

| | | Before | After | Shift | | |
|---|---|---|---|---|---|---|
| | | tilt | tilt | value | | Mould |
| No. | Feature | (um) | (um) | (um) | Remark | Group |
| 1 | Distance | 0.5794 | 0.5738 | 0.0055 | Without lens | 1 |
| 2 | Distance | 0.5665 | 0.5691 | −0.0025 | Without lens | 1 |
| 3 | Distance | 0.5765 | 0.5785 | −0.0020 | With ball lens | 2 |
| 4 | Distance | 0.6809 | 0.6796 | 0.0013 | With ball lens | 2 |
| 5 | Distance | 0.5330 | 0.5332 | −0.0002 | With ball lens | 2 |
| 6 | Distance | 0.6523 | 0.6518 | 0.0005 | With column | 3 |
| | | | | | lens | |
| 7 | Distance | 0.6664 | 0.6653 | 0.0011 | With column | 3 |
| | | | | | lens | |
| 8 | Distance | 0.7001 | 0.6976 | 0.0025 | With column | 3 |
| | | | | | lens | |

TABLE 2
(0.15 W 7 S UV curing)

| | | Before | After | Shift | | |
|---|---|---|---|---|---|---|
| | | tilt | tilt | value | | Mould |
| No. | Feature | (um) | (um) | (um) | Remark | Group |
| 1 | Distance | 0.4125 | 0.4152 | 0.0027 | Without lens | 1 |
| 2 | Distance | 0.6751 | 0.6778 | 0.0027 | Without lens | 1 |
| 3 | Distance | 0.5902 | 0.5907 | 0.0006 | With ball lens | 2 |
| 4 | Distance | 0.5687 | 0.5680 | −0.0008 | With ball lens | 2 |
| 5 | Distance | 0.6295 | 0.6306 | 0.0011 | With ball lens | 2 |
| 6 | Distance | 0.7008 | 0.7035 | 0.0027 | With column | 3 |
| | | | | | lens | |
| 7 | Distance | 0.7524 | 0.7544 | 0.0020 | With column | 3 |
| | | | | | lens | |
| 8 | Distance | 0.8425 | 0.8423 | −0.0002 | With column | 3 |
| | | | | | lens | |

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. An adhesive bonding method, comprising:
providing a first component and a second component to be bonded together, and an adhesive;
positioning the adhesive between the first component and the second component with the adhesive contacting with the first component and the second component;
providing at least one light concentrator; and
providing a light source and making at least partial light beams of the light source pass through the light concentrator and the first component in order, and then irradiate on the adhesive to cure the adhesive so as to bond the first component and the second component.

2. The adhesive bonding method according to claim 1, wherein the light concentrator is a lens or a focuser or a light guide with light input aperture larger than exit end.

3. The adhesive bonding method according to claim 2, wherein the lens is a spherical lens, a cylindrical lens, a polygonal-cylindrical lens, or an aspheric-cylindrical lens.

4. The adhesive bonding method according to claim 1, wherein the light concentrator has a diffractive optical surface for concentrating the light beams.

5. The adhesive bonding method according to claim 1, wherein the step of providing at least one light concentrator is accomplished by integrally forming the light concentrator on the first component.

6. The adhesive bonding method according to claim 1, wherein the step of providing at least one light concentrator is accomplished by embedding the light concentrator into the first component.

7. The adhesive bonding method according to claim 1, wherein the step of providing at least one light concentrator is accomplished by placing the light concentrator above the first component.

8. The adhesive bonding method according to claim 1, further comprising: a step of optically aligning the first component with the second component.

9. The adhesive bonding method according to claim 6, further comprising: a step of monitoring the alignment between the first component and the second component.

10. A plate installing device installed on a plate by an adhesive, comprising:
a first surface adapted to touch with the adhesive attached on the plate; and
a second surface opposite to the first surface, wherein a light concentrator is deposited on the second surface at a position corresponding to the adhesive.

11. The plate installing device according to claim 10, wherein the plate installing device is an active optical cable, and the plate is a printed circuit board, a substrate, a chip or a lead frame.

12. The plate installing device according to claim 10, wherein the light concentrator is,integrally formed on the second surface or embedded into the second surface as a separated element.

13. The plate installing device according to claim 10, wherein the light concentrator is a lens or a focuser or a light guide with light input aperture larger than exit end.

14. The plate installing device according to claim 13, wherein the lens is a spherical lens, a cylindrical lens, a polygonal-cylindrical lens, or an aspheric-cylindrical lens.

15. The plate installing device according to claim 10, wherein the light concentrator has a diffractive optical surface for concentrating the light beams.
